(19) United States
(12) Patent Application Publication
(10) Pub. No.: US 2002/0058090 A1
(43) Pub. Date: May 16, 2002

(54) Food product or food additive product having a chemiluminescent stick

(76) Inventor: Zak Siddons, Macedonia, OH (US)

Correspondence Address: FAY, SHARPE, BEALL, FAGAN,, MINNICH & McKEE, Suite 700, 1100 Superior Avenue, Cleveland, OH, 44114-2516, US

(21) Appl. No.: 09/975,368

(22) Filed: Oct. 11, 2001

Related U.S. Application Data
(60) Provisional application No. 60/239,405, filed on Oct. 11, 2000.

(51) Int. Cl. A23L 1/00; A21D 2/00

(52) U.S. Cl. 426/101; 426/104

(57) ABSTRACT

The present invention is directed to a frozen food dessert assembly. The frozen food dessert assembly includes a chemiluminescent stick and a frozen food or food additive partially disposed about one end of the stick. Preferably, a tubing material or wrapping film is disposed about the chemiluminescent stick. The ends of the stick may include different shapes. Also, at least one of the ends of the stick may include a hook or a handle. The stick can define an aperture proximate to at least one of its ends.

### CROSS REFERENCES TO RELATED APPLICATIONS

The present application is based on U.S. Provisional Application Serial No. 60/239,405, filed Oct. 11, 2000.

### FIELD OF THE INVENTION

The present invention is directed to a frozen food dessert assembly having a food product or food additive, such as ice cream or other frozen dessert, partially disposed about a chemiluminescent stick.

### BACKGROUND OF THE INVENTION

Frozen desserts such as ice cream have long been a favorite of the consuming public. In one form ice cream is formed into bars with a protruding handle or stick and covered with a flavored topping such as chocolate. This form provides a single portion quantity of ice cream and permits handling of the ice cream with the fingers of the consumer, i.e., the consumer is not restricted to a dish and spoon or cone to enjoy the ice cream.

Chemiluminescent sticks are also very popular with the consuming public. Chemiluminescent sticks are sticks that provide a glow for a relatively short period of time. Chemiluminescent sticks are also very safe for users as they are relatively cold due to its chemical composition and cannot cause fire or explosion.

It would be desirable to have a frozen food product on a stick, where the stick would be further enjoyed by sight and use during or after consumption of the frozen food product.

### SUMMARY OF THE INVENTION

The present invention is a frozen dessert assembly. The assembly includes a frozen food or food additive disposed about a chemiluminescent stick. The frozen dessert can be any known frozen dessert, such as ice cream, frozen water based flavored foods commonly referred to popsicles, etc. The frozen dessert may further include alcohol based food for alcoholic consumption.

Preferably, the chemiluminescent stick can have many different features. The stick can be of any desired length. Preferably, the stick is between about 4 to 10 inches. Also, the stick can exhibit the glow of any known color. Furthermore, the stick may further include a thin plastic material about the stick. The stick may have a cylindrically shaped plastic material disposed about the stick that can be removed after consumption of the frozen food product. The end of the chemiluminescent stick opposite the portion having the frozen food product may further have a hook shape that can attach to other objects upon removal of the frozen food or food additive product.

The invention will be further understood from the detailed description and the drawings.

### BRIEF DESCRIPTION OF THE DRAWINGS

FIG. 1 shows a cross-sectional perspective view of one embodiment of a frozen food dessert assembly including a chemiluminescent stick and a food product or food additive partially disposed about an end and a portion of the chemiluminescent stick.

FIG. 2 shows a cross-sectional perspective view of another embodiment of a frozen food assembly including a tubing material disposed about a chemiluminescent stick. The tubing material and chemiluminescent stick is partially surrounded by a food product or food additive.

FIG. 3A shows a cross-sectional perspective view of another embodiment of a frozen food assembly including a wrapping film disposed about a chemiluminescent stick. The wrapping film and chemiluminescent stick is partially surrounded by a generally rectangular food product.

FIG. 3B shows a cross-sectional side view of a frozen food assembly including a wrapping film disposed about a chemiluminescent stick. The wrapping film and chemiluminescent stick is partially surrounded by a generally rectangular food product.

### DETAILED DESCRIPTION OF THE PREFERRED EMBODIMENTS

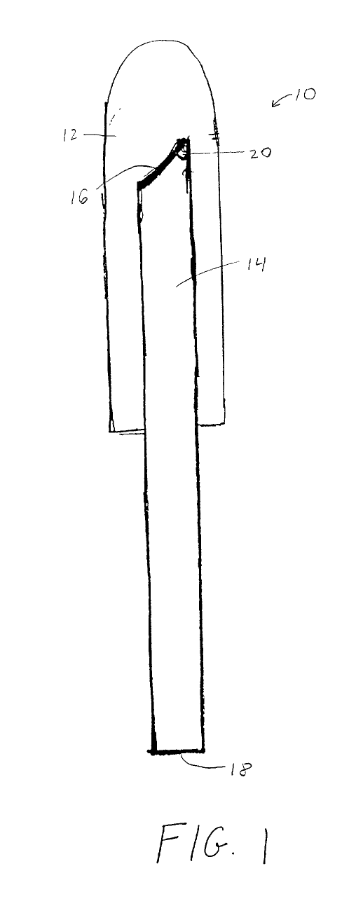

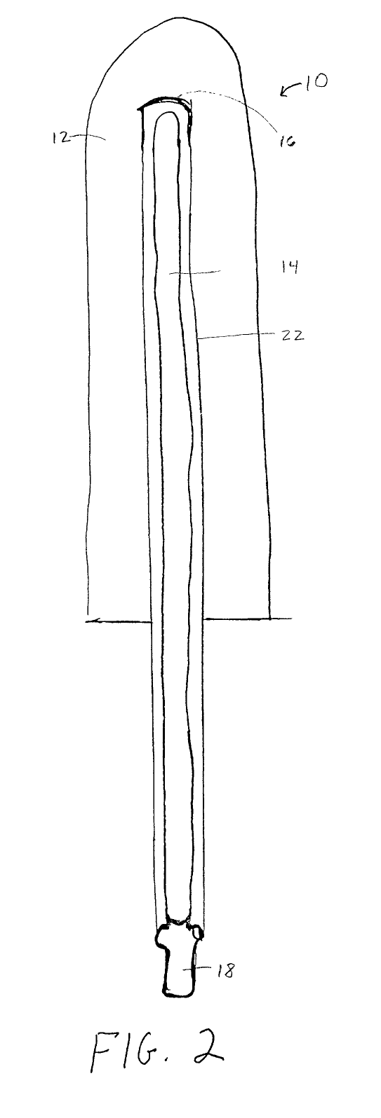

FIG. 1 shows a frozen food dessert assembly 10 including a frozen food or food additive 12 disposed about a chemiluminescence stick 14. The chemiluminescent stick ends 16 and 18 can have various shapes. Particularly, FIG. 1 shows the chemiluminescent stick end 16 having an angular shape. FIG. 2 shows the chemiluminescent stick end 16 having a partial rectangular shape. Other shapes for the chemiluminescent stick ends 16 and 18 include circular, oval, polygonal, etc. One or both of the ends 16 and 18 may also include a hook shape which can attach to various objects upon removal of the food product or food additive containing product.

FIG. 1 further shows a portion near one or both of the ends 16 and 18 of the chemiluminescent stick 14 may define an aperture 20. A user may use the aperture 20 for inserting and attaching a string or similar object through the aperture 20.

FIG. 2 shows the chemiluminescent stick 14 having a tubing material 22 generally surrounding the stick 14 to provide protection of the chemiluminescent stick 14 from the food product or food additive containing product 12. The tubing material 22 generally has a cylindrical shape, although the material 22 can encompass any shape so long as it surrounds the stick 14. Chemiluminescent stick end 18 is preferably in the shape of a handle to allow the user to pull and remove the chemiluminescent stick 14 from the tubing material 22 surrounding it. The end 18 preferably extends beyond the end of the tubing material 22 in order to improve the ease in which the user may pull and remove the chemiluminescent stick 14. Preferably, the tubing material 22 is formed from plastic.

FIG. 2 shows that the end 18 opposite the end where the frozen food 12 is disposed about can be in the shape of a handle so that a user may grip or hold the dessert assembly 10 from the end 18.

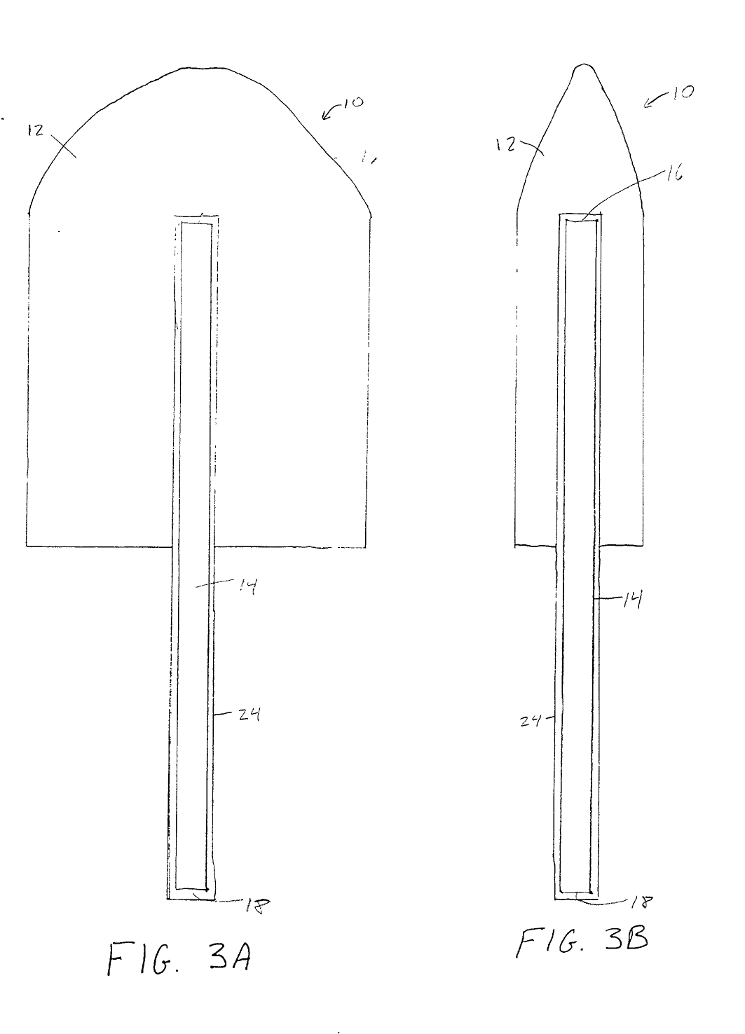

FIGS. 3A and 3B show a wrapping film 24 disposed about the chemiluminescent stick 14. The food or food additive 12 is disposed over the wrapping film 24. The wrapping film 24 acts as a barrier between the food or food additive 12 and the chemiluminescent stick 14 and prevents potential accidental leakage of chemicals within the chemiluminescent stick 14 into the food or food additive 12. The wrapping film 24 is relatively thin and is preferably formed from a plastic material. The wrapping film 24 can be transparent or can include one or more colors. The wrapping film 24 can include printed material such as written material or printed designs. The wrapping film 24 may be removed by the user, preferably after the food product has been displaced from the thin plastic film.

As shown in FIGS. 1, 2, 3A, and 3B, the frozen food or food additive 12 can be of any shape or size. Also, the frozen food or food additive 12 can be the shape of particular character faces, sporting equipment (e.g., in the shape of a football, soccer ball, etc.), etc. Also, a frozen food or food additive may be disposed about two or more chemiluminescent sticks so that the single dessert formed may have a plurality of sticks.

The chemiluminescent stick includes a tube. A plurality of chemical reactants are located within the tube and are separated by a capsule. Activation is accomplished by bending the lightstick to break the capsule. The breakage of the capsule causes the chemical reactants to blend and react. The reaction causes and illumination of the stick. It is noted that the tube is different from the tubing material 22 as shown in FIG. 2.

The chemiluminescent stick can be of any desired length and width. Preferably, the stick comprising chemiluminescent material is between about 4 and 10 inches and more preferably between about 6 and 8 inches.

The chemiluminescent stick converts the energy released in a chemical reaction directly to light without the involvement of heat or flame. Particularly, the chemiluminescent stick includes a combination of fluorescence and an excitation reaction.

Preferably, the excitation reaction must be capable of generating at least 40 to 70 kilocalories/mole of energy, the energy range of visible light. In addition to substantial instantaneous energy release and the formation of a fluorescent product, the distribution of energy released from a reaction between light emitting (or electronic) excited states and heat emitting (or vibrational) excited states must be achieved.

The first step is essentially conventional chemistry producing a key intermediate (K1). The second step is the excitation process where the chemical energy of K1 is converted and transferred to electronic excitation energy in a separate fluorescent chemical molecule (fluorescer). The third step is conventional fluorescent emission.

The efficiency of K1 is an important aspect of the overall chemiluminescence process. The efficiency of K1 is based upon its high energy content, its ability to release its energy instantaneously through a concerted peroxide decomposition reaction, the quantum mechanical reluctance of a small molecule like carbon dioxide to accept a large amount of chemical energy as heat, and the inability of carbon dioxide itself to become electronically excited by the available energy.

Since K1 does not have a favorable pathway by which it can remove unwanted energy, K1 has an appreciable lifetime. On the other hand, because of its energy content, K1 can decompose when it encounters a fluorescer with the ability to accept its energy. The fluorescer thus acts as a catalyst for the decomposition of K1, and this catalyst is an important factor in the efficiency of this chemical reaction.

Because the fluorescer is separate from the energy producing components of the reaction, it can be varied without changing the basic chemistry. Since the color of the light depends on the fluorescer selected, peroxyoxalate chemiluminescence can be formulated in any color desired.

The chemiluminescent light is desirable in part because it is cold and cannot cause fire or explosion. Various chemiluminescent compositions may be used in accordance with the present invention. For example, see U.S. Pat. Nos. 4,678,608, 4,717,511, 5,232,635, 5,122,306, 4,313,843 herein incorporated by reference.

The food product and food additives used in accordance with the present invention include any frozen food product or food additive. Preferably, the food product or food additive is a frozen dessert, such as ice cream or a frozen water-based product, such as a popsicle. The frozen water-based food or food additive may optionally include ethanol-based alcohol for consumption.

The foregoing description is, at present, considered to be the preferred embodiments of the present invention. However, it is contemplated that various changes and modifications apparent to those skilled in the art, may be made without departing from the present invention. Therefore, the foregoing description is intended to cover all such changes and modifications encompassed within the spirit and scope of the present invention, including all equivalent aspects.

Having thus described the preferred embodiments, what is claimed is:

1. A frozen food dessert assembly comprising:
a chemiluminescent stick having a generally a cylindrical shape; and
a frozen food partially disposed about one end of said chemiluminescent stick.

2. The frozen food dessert assembly of claim 1, wherein said chemiluminescent stick defines an aperture near at least one end of said stick.

3. The frozen food dessert assembly of claim 1, wherein a tubing material is disposed about said chemiluminescent stick, said chemiluminescent stick being removable from said tubing material and said frozen food is disposed on a portion of said tubing material.

4. The frozen food dessert assembly of claim 3, wherein the end of said chemiluminescent stick opposite the end adjacent to said frozen food comprises a handle.

5. The frozen food dessert assembly of claim 1, wherein said frozen food dessert further includes a wrapping film is disposed about said chemiluminescent stick, said wrapping film removable from said chemiluminescent stick, and said frozen food is disposed about one end of said wrapping film.

6. The frozen food dessert assembly of claim 1, wherein at least one end of said chemiluminescent stick is hook shaped.

7. The frozen food dessert assembly of claim 1, wherein at least one end of said chemiluminescent stick has an angular, circular, rectangular, or polygonal shape.

8. The frozen food dessert assembly of claim 1, wherein said chemiluminescent stick has a width of from about 4 to about 10 inches.
